(19) United States
(12) Patent Application Publication
(10) Pub. No.: US 2023/0080738 A1
(43) Pub. Date: Mar. 16, 2023

(54) MANAGEMENT APPARATUS, NON-TRANSITORY COMPUTER READABLE MEDIUM, AND MANAGEMENT METHOD

(71) Applicant: FUJIFILM Business Innovation Corp., Tokyo (JP)

(72) Inventor: Shinsuke NAGATA, Kanagawa (JP)

(73) Assignee: FUJIFILM Business Innovation Corp., Tokyo (JP)

(21) Appl. No.: 17/700,528

(22) Filed: Mar. 22, 2022

(30) Foreign Application Priority Data
Sep. 10, 2021 (JP) 2021-148167

(51) Int. Cl. G06F 21/60; G06F 21/44; G06F 21/62

(52) U.S. Cl. CPC G06F 21/606; G06F 21/44; G06F 21/6218; G06F 2221/2113

(57) ABSTRACT

A management apparatus includes a processor configured to, in a case where setting information is transmitted to an information processing apparatus in which setting information concerning security of the information processing apparatus is remotely settable for each user, perform control so that setting information already set in the information processing apparatus is not updated.

### CROSS-REFERENCE TO RELATED APPLICATIONS

This application is based on and claims priority under 35 USC 119 from Japanese Patent Application No. 2021-148167 filed Sep. 10, 2021.

### BACKGROUND

### (i) Technical Field

The present disclosure relates to a management apparatus, a non-transitory computer readable medium, and a management method.

### (ii) Related Art

Japanese Unexamined Patent Application Publication No. 2014-182689 discloses an information processing apparatus including a first receiving unit that receives, from a first information processing apparatus, reservation processing of reserving transmission of management setting processing performed by a second information processing apparatus and information related to a time zone in which the second information processing apparatus executes management setting processing, a registration unit that registers, in a storage unit, information concerning the reservation processing and the time zone received by the first receiving unit, a request unit that in a case where a time of reception of communication from the second information processing apparatus matches the information related to the time zone stored in the storage unit, requests transmission of management setting processing performed by the second information processing apparatus that corresponds to the time zone to the first information processing apparatus, a second receiving unit that receives the management setting processing performed by the second information processing apparatus from the first information processing apparatus in response to the request made by the request unit, and a transmitting unit that transmits the management setting processing received by the second receiving unit to the second information processing apparatus.

Japanese Unexamined Patent Application Publication No. 2012-217203 discloses an image processing apparatus that is communicable with an information processing apparatus over a network and includes a receiving unit that receives remote control information for changing a setting value of the image processing apparatus from the information processing apparatus over the network, and a display control unit that causes a screen for inquiring of a user whether or not to permit change of the setting value to be displayed on the image processing apparatus in accordance with reception of the remote control information by the receiving unit.

Japanese Unexamined Patent Application Publication No. 2016-126690 discloses a management apparatus that communicates with plural information processing apparatuses and includes a management unit that acquires setting data managed by the information processing apparatuses and registers and manages the setting data in the storage unit, a first determining unit that determines whether setting data to be subjected to a data update request is a target for which a competitive property is to be checked based on management information set for the setting data in a case where a request to setting data which is received from any of the information processing apparatuses and is registered in the storage unit is a data update request that is a synchronous request, a second determining unit that determines whether or not the setting data including relevant data associated with the setting data in the storage unit s competitive in a case where it is determined that the setting data is a target for which a competitive property is to be checked, and an instruction unit that instructs the management unit to set information indicating that the setting data is not a synchronous target in a case where it is determined that the setting data including relevant data associated with the setting data is competitive.

### SUMMARY

Aspects of non-limiting embodiments of the present disclosure relate to a management apparatus, a non-transitory computer readable medium, and a management method that can prevent erroneous transmission by an information processing apparatus in which setting information concerning security of the information processing apparatus can be remotely set for each user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a management apparatus including: a processor configured to, in a case where setting information is transmitted to an information processing apparatus in which setting information concerning security of the information processing apparatus is remotely settable for each user, perform control so that setting information already set in the information processing apparatus is not updated.

### BRIEF DESCRIPTION OF THE DRAWINGS

Exemplary embodiments of the present disclosure will be described in detail based on the following figures, wherein:

FIG. 1 is a schematic configuration view illustrating a configuration of an information processing system;

FIG. 2 is a block diagram illustrating a hardware configuration of a management apparatus;

FIG. 3 illustrates an example of setting information related to remote setting;

FIG. 4 is a flowchart illustrating an example of a flow of management processing according to a first exemplary embodiment;

FIG. 5 illustrates an example of registered setting information;

FIG. 6 illustrates an example of setting information related to remote setting; and

FIG. 7 is a flowchart illustrating an example of a flow of management processing according to a second exemplary embodiment.

### DETAILED DESCRIPTION

Embodiments of the present disclosure are described in detail below with reference to the drawings.

### First Exemplary Embodiment

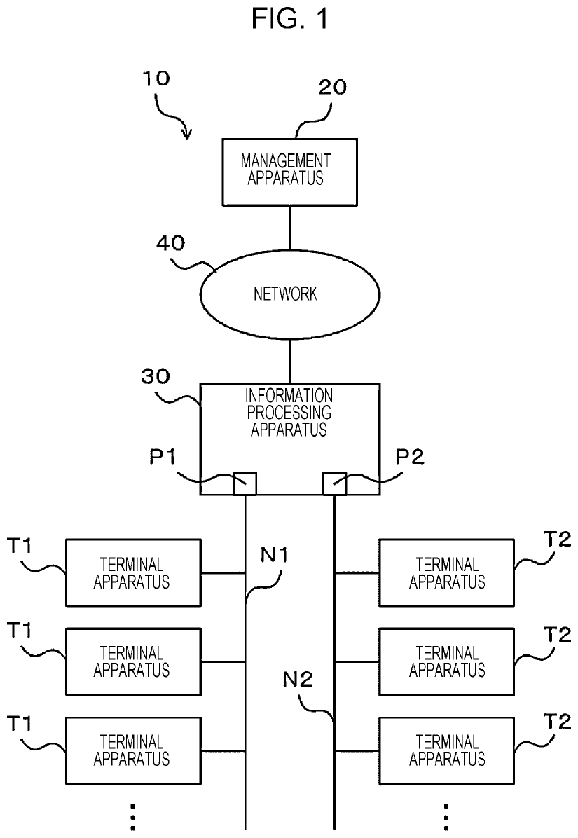

FIG. 1 illustrates a configuration of an information processing system 10 according to the present exemplary embodiment. The information processing system 10 includes a management apparatus 20 and an information processing apparatus 30 that are connected over a network 40.

The information processing apparatus 30 includes plural (two in FIG. 1) different communication ports P1 and P2. To the communication port P1, plural terminal apparatuses T1 are connected over a communication line N1. To the communication port P2, plural terminal apparatuses T2 are connected over a communication line N2 different from the communication line N1. That is, the information processing apparatus 30 is connectable to the two different systems of communication lines N1 and N2 that are separated from each other.

Although a case where the information processing apparatus 30 is an image forming apparatus having various functions concerning image formation such as a copy function, a scan function, and a facsimile transmission and reception, which are functions concerning image formation processing is described as an example in the present exemplary embodiment, the information processing apparatus 30 is not limited to an image forming apparatus. Note that the scan function includes a function of transmitting an image read from a document to a designated e-mail address. Furthermore, the facsimile transmission and reception function includes a function of transmitting an image received by facsimile to a designated e-mail address.

Although the information processing apparatus 30 has the two communication ports P1 and P2 in the example of FIG. 1, the information processing apparatus 30 may include three or more communication ports and be connectable to three or more communication lines.

In the present exemplary embodiment, the communication line N1 and the communication line N2 are separate communication lines, as illustrated in FIG. 1. That is, the communication line N1 and the communication line N2 are two independent systems of communication lines. Accordingly, a terminal apparatus T1 and a terminal apparatus T2 that are connected to different communication lines cannot communicate with each other although the terminal apparatuses T1 can communicate with each other and the terminal apparatuses T2 can communicate with each other.

In the present exemplary embodiment, a case where the communication line N1 and the communication line N2 are communication lines that are different in security level is described. Specifically, a case where the communication line N1 is a communication line such as the Internet open to the public and the communication line N2 is a communication line that is not open to the public is described. Note that the communication lines N1 and N2 are not limited to this example. For example, the communication line N1 may be a communication line to which terminal apparatuses T1 handling highly-confidential patient information such as medical records in a hospital are connected, and the communication line N2 may be a communication line to which terminal apparatuses T2 handling less-confidential information, such as accounting data in the same hospital, than the patient information are connected. For example, in a case where the information processing apparatus 30 is placed in a workplace in which employees of plural companies work together, the communication line N1 may be a communication line for a company A, and the communication line N2 may be a communication line for a company B.

The management apparatus 20 manages setting information concerning various functions offered by the information processing apparatus 30. The management apparatus 20 transmits setting information to the information processing apparatus 30 and sets the setting information in the information processing apparatus 30 over the network 40. This will be described later in detail. That is, the management apparatus 20 can remotely set setting information in the information processing apparatus 30. Note that setting information can also be set by operator's direct operation of the information processing apparatus 30.

That is, there are two methods of setting setting information in the information processing apparatus 30, specifically, a method of remote setting from the management apparatus 20 and a method of direct operation of the information processing apparatus 30.

The setting information includes setting information concerning security. The setting information concerning security is setting information such that in a case where the setting information has an error, there is a possibility of erroneous transmission of information processed by the information processing apparatus 30. The setting information concerning security is, for example, information on a communication line available to a user. Another example of the setting information concerning security is information on a user's e-mail address necessary for e-mail transmission of information processed by the information processing apparatus 30 such as an image scanned from a document or an image received by facsimile. Note that the setting information concerning security is not limited to these examples.

As for setting information irrelevant with security, there is a low risk of occurrence of a problem even if setting information is already set by operator's direct operation of the information processing apparatus 30 and setting information different from the setting information already set in the information processing apparatus 30 is set by remote setting from the management apparatus 20. Meanwhile, as for setting information concerning security, there is a risk of occurrence of a security problem in a case where setting information is already set by operator's direct operation of the information processing apparatus 30 and setting information different from the setting information already set in the information processing apparatus 30 is set by remote setting from the management apparatus 20.

For example, assume that in a case where the communication line N1 is a communication line such as the Internet open to the public and the communication line N2 is a communication line that is not open to the public, setting information for setting the open communication line N1 as a communication line available to a user 1 is already set in the information processing apparatus 30. In this case, in a case where the management apparatus 20 sets the communication line available to the user 1 to the communication line N2 that is not open to the public by remote setting, the user 1, who cannot use the communication line N2 that is not open to the public, becomes able to use the communication line N2 that is not open to the public. This may pose a security problem.

In view of this, the management apparatus 20 performs control so that setting information already set in the information processing apparatus 30 is not updated in a case where setting information is transmitted to the information processing apparatus 30 in which setting information concerning security of the information processing apparatus 30 can be remotely set for each user.

Specifically, in a case where the setting information includes setting information concerning security, the management apparatus 20 does not transmit a Set command, which is a command to register the setting information in the information processing apparatus 30 in an overwriting manner but transmit an Add command, which is an addition command to additionally register the setting information in the information processing apparatus 30, to the information processing apparatus 30. This will be described in detail later.

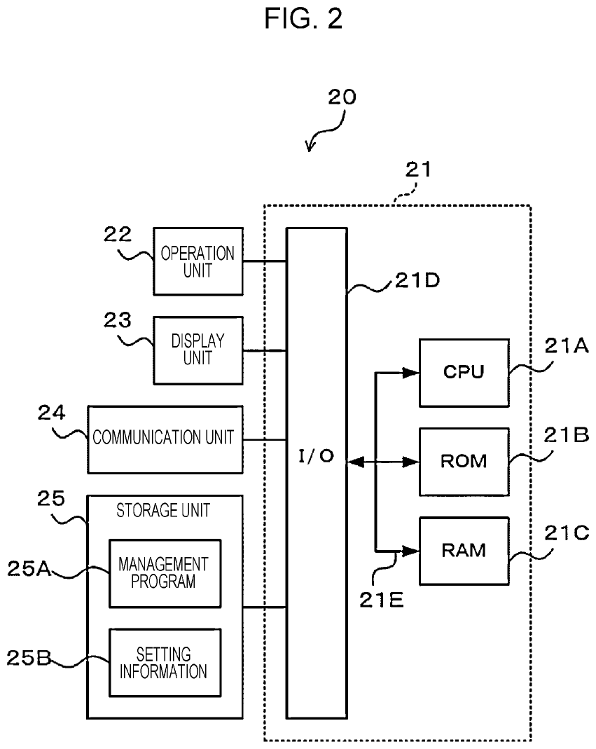

FIG. 2 is a block diagram illustrating a hardware configuration of the management apparatus 20. As illustrated in FIG. 2, the management apparatus 20 includes a controller 21. The controller 21 is a general computer and includes a central processing unit (CPU) 21A, a read only memory (ROM) 21B, a random access memory (RAM) 21C, and an input output interface (I/O) 21D. The CPU 21A, the ROM 21B, the RAM 21C, and the I/O 21D are connected over a system bus 21E. The system bus 21E includes a control bus, an address bus, and a data bus. The CPU 21A is an example of a processor.

The I/O 21D is connected to an operation unit 22, a display unit 23, a communication unit 24, and a storage unit 25.

The operation unit 22 includes, for example, a mouse and a keyboard.

The display unit 23 is, for example, a liquid crystal display.

The communication unit 24 is an interface for data communication with an external apparatus such as the information processing apparatus 30.

The storage unit 25 is a non-volatile external storage device such as a hard disk and stores therein a management program 25A, a setting information 25B, and the like, which will be described later. The CPU 21A loads the management program 25A stored in the storage unit 25 into the RAM 21C and executes the management program 25A.

The setting information 25B is setting information related to remote setting, that is, setting information transmitted from the management apparatus 20 to the information processing apparatus 30 and set in the information processing apparatus 30.

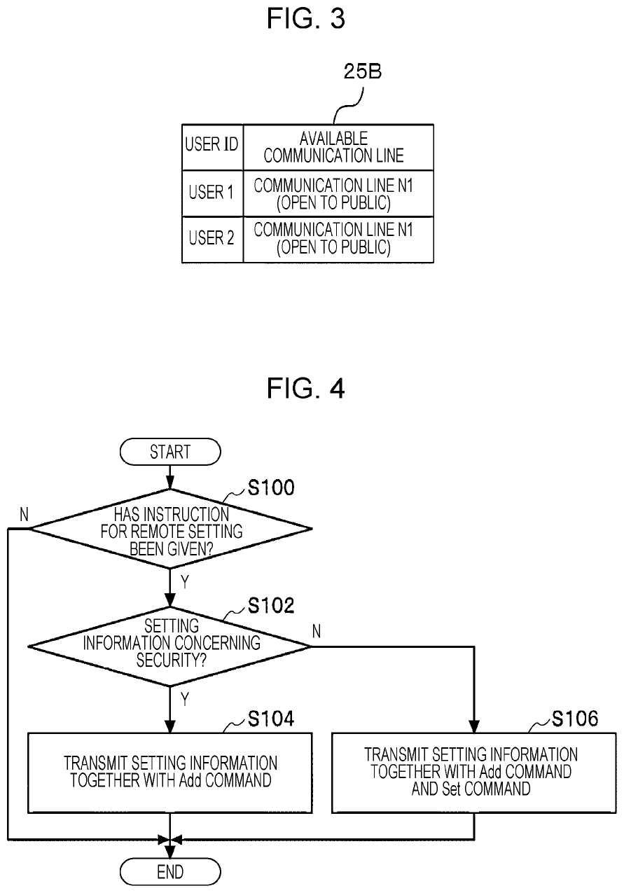

As illustrated in FIG. 3, the setting information 25B related to remote setting is setting information concerning security among setting information remotely set in the information processing apparatus 30 from the management apparatus 20. Specifically, the setting information 25B is information representing correspondences between user IDs and available communication lines. In the example of FIG. 3, both of communication lines available to users 1 and 2 are set to the communication line N1 open to the public. Note that the setting information 25B remotely set in the information processing apparatus 30 can be set by an operator operating the operation unit 22 on a setting information registration screen (not illustrated).

The storage unit 25 stores therein, for example, setting information irrelevant with security as setting information set in the information processing apparatus 30 in addition to the setting information 25B.

Next, management processing executed by the CPU 21A of the management apparatus 20 is described with reference to the flowchart illustrated in FIG. 4. Note that processing of FIG. 4 is repeatedly executed.

In step S100, the CPU 21A determines whether or not an instruction to remotely set setting information in the information processing apparatus 30 has been given by operator's operation. In a case where a result of the determination in step S100 is positive, step S102 is performed, and in a case where the result of the determination in step S100 is negative, this routine is finished.

In step S102, the CPU 21A determines whether or not the setting information is setting information concerning security. Specifically, the CPU 21A determines whether or not an instruction to remotely set the setting information 25B concerning security has been given. In a case where a result of the determination in step S102 is positive, step S104 is performed. Meanwhile, in a case where the result of the determination in step S102 is negative, that is, in a case where the setting information is setting information irrelevant with security, step S106 is performed.

In step S104, the CPU 21A transmits the setting information 25B to the information processing apparatus 30 together with an Add command. The Add command is an addition command to additionally register the setting information 25B in the information processing apparatus 30. That is, the setting information 25B is additionally registered for a user who has not been registered in the information processing apparatus 30 without overwriting setting information as for a user who has been already registered in the information processing apparatus 30.

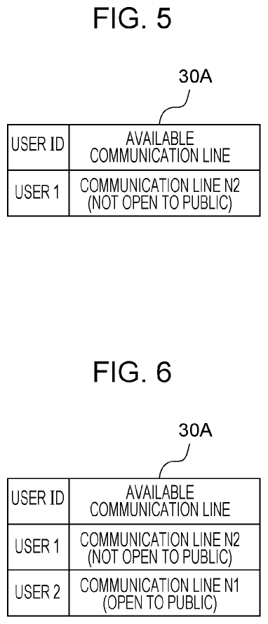

For example, assume that registered setting information 30A (see FIG. 5) has been already set in the information processing apparatus 30. In the example of FIG. 5, a communication line available to the user 1 is set to the communication line N2 that is not open to the public. In this case, since setting information of the user 2 has not been set in the registered setting information 30A, setting information of the user 2 in the setting information 25B related to remote setting is additionally set in the information processing apparatus 30, and the registered setting information 30A is updated as illustrated in FIG. 6.

Since the setting information of the user 1 that has been already set in the information processing apparatus 30 is not updated, there is no risk of erroneous transmission of information processed by the information processing apparatus 30 concerning the user 1 to the communication line N1 open to the public instead of the communication line N2 that is available to the user 1 and is not open to the public.

Meanwhile, in step S106, the CPU 21A transmits the setting information irrelevant with security to the information processing apparatus 30 together with an Add command and a Set command. The Set command is an overwriting command to register the setting information in the information processing apparatus 30 in an overwriting manner, as described above. Accordingly, the setting information of a user that has been already set in the information processing apparatus 30 is overwritten with the setting information transmitted from the management apparatus 20. Furthermore, setting information of a user that has not been set in the information processing apparatus 30 yet in the setting information transmitted from the management apparatus 20 is additionally set. In this way, in a case where the setting information for which the instruction of remote setting has been given is setting information irrelevant with security, there is a low risk of occurrence of a security problem even in a case where setting information has been already set in the information processing apparatus 30, and therefore the setting information is overwritten for convenience of remote setting.

### Second Exemplary Embodiment

Next, a second exemplary embodiment is described. Note that a configuration of an information processing system 10 is identical to that in the first exemplary embodiment, and therefore description thereof is omitted.

In the second exemplary embodiment, in a case where setting information includes setting information concerning security, a management apparatus 20 acquires registered setting information registered in an information processing apparatus 30 and transmits a registration prohibition command to prohibit registration of setting information other than remote setting to the information processing apparatus 30. Furthermore, the management apparatus 20 gives a notification in a case where the acquired registered setting information and the setting information related to remote setting are different.

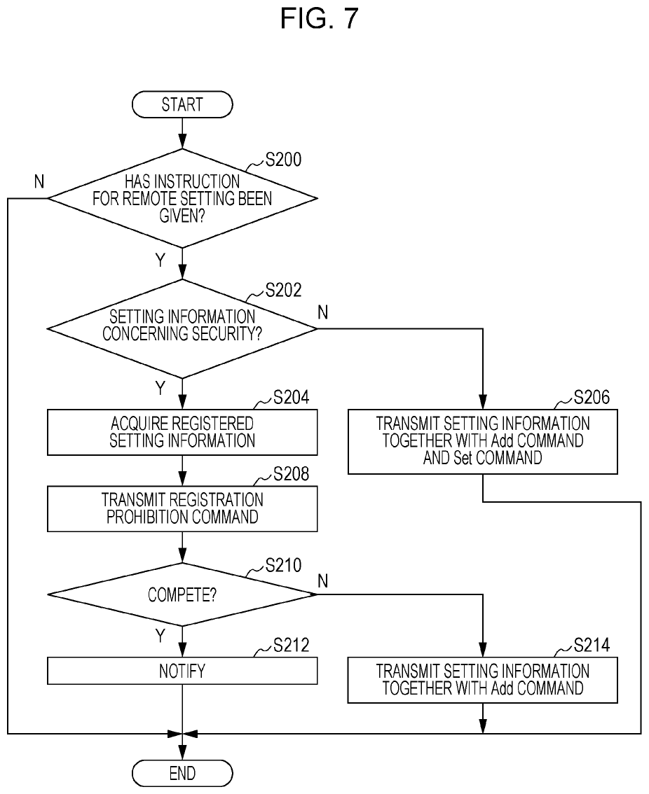

Next, management processing executed by a CPU 21A of the management apparatus 20 is described with reference to the flowchart illustrated in FIG. 7. The processing in FIG. 7 is repeatedly executed.

Processes in steps S200 and S202 are identical to those in steps S100 and S102 in FIG. 4, and therefore description thereof is omitted.

In a case where a result of the determination in step S202 is positive, step S204 is performed, and in a case where the result of the determination in step S202 is negative, step S206 is performed. Note that a process in step S206 is identical to that in step S106 in FIG. 4, and therefore description thereof is omitted.

In step S204, the CPU 21A transmits a Get command, which is a command to acquire registered setting information 30A set in the information processing apparatus 30, to the information processing apparatus 30. Upon receipt of the Get command from the management apparatus 20, the information processing apparatus 30 transmits the registered setting information 30A to the management apparatus 20. In this way, the management apparatus 20 acquires the registered setting information 30A.

In step S208, the CPU 21A transmits a registration prohibition command to prohibit registration of setting information other than remote setting to the information processing apparatus 30. In the present exemplary embodiment, for example, a registration prohibition command to prohibit registration of setting information other than remote setting for a certain period is transmitted to the information processing apparatus 30. The certain period is set to several minutes to several tens of minutes, for example, to 10 minutes but is not limited to this. In this way, registering setting information by directly operating the information processing apparatus 30 is prohibited for the certain period.

In step S210, the CPU 21A determines whether or not the registered setting information 30A acquired in step S204 and the setting information 25B related to remote setting compete each other. That is, the CPU 21A determines whether or not different pieces of setting information are set for the same user by comparing the registered setting information 30A acquired in step S204 and the setting information 25B related to remote setting. For example, assume that the registered setting information is the registered setting information 30A illustrated in FIG. 5 and the setting information related to remote setting is the setting information 25B illustrated in FIG. 3. In this case, a communication line available to the user 1 is set to the communication line N2 in the registered setting information 30A, but the communication line available to the user 1 is set to the communication line N1 in the setting information 25B related to the remote setting. Therefore, it is determined that the registered setting information 30A acquired in step S204 and the setting information 25B related to remote setting compete each other.

Then, in a case where a result of the determination in step S210 is positive, step S212 is performed, and in a case where the result of the determination in step S210 is negative, step S214 is performed. Note that a process in step S214 is identical to that in step S104 of FIG. 4, and therefore description thereof is omitted.

In step S212, the CPU 21A gives a notification indicating that the registered setting information 30A and the setting information 25B related to remote setting compete each other. Specifically, the CPU 21A causes contents of competition between the registered setting information 30A and the setting information 25B related to remote setting to be displayed on a display unit 23. This allows an operator to grasp that the registered setting information 30A and the setting information 25B related to remote setting compete each other and perform an operation such as changing the setting information 25B related to remote setting so that the competition disappears.

In this way, the registered setting information 30A already set in the information processing apparatus 30 is acquired, and in a case where the registered setting information 30A competes with the setting information 25B related to remote setting, a registration prohibition command is transmitted to the information processing apparatus 30 and a notification is given. This prompts an operator to make adjustment so that the registered setting information 30A and the setting information 25B related to remote setting become consistent with each other.

Although a case where setting information is a communication line available to a user has been described above in the above exemplary embodiments, it is needless to say that the processing described in the above exemplary embodiments are also executable even in a case where setting information is a user's e-mail address instead of a communication line.

The flow of the processing of the management program 25A (see FIGS. 4 and 7) described in the above exemplary embodiments are an example, and it is needless to say that an unnecessary step may be deleted, a new step may be added, and a processing order may be changed without departing from the spirit of the present disclosure.

Furthermore, the configuration of the management apparatus 20 (see FIG. 2) is also an example, and it is needless to say that an unnecessary part may be deleted and a new part may be added without departing from the spirit of the present disclosure.

Although a form in which a management program is installed in the storage unit 25 has been described in the present exemplary embodiment, this is not restrictive. The management program 25A according to the present exemplary embodiment may be offered by being recorded in a computer-readable storage medium. For example, an information processing program according to the present exemplary embodiment may be offered by being recorded in an optical disc such as a CD (Compact Disc)-ROM or a DVD (Digital Versatile Disc)-ROM or by being recorded in a semiconductor memory such as a universal serial bus (USB) memory or a memory card. The information processing program according to the present exemplary embodiment may be acquired from an external apparatus over a communication line connected to the communication unit 24.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A management apparatus comprising:
a processor configured to, in a case where setting information is transmitted to an information processing apparatus in which setting information concerning security of the information processing apparatus is remotely settable for each user, perform control so that setting information already set in the information processing apparatus is not updated.

2. The management apparatus according to claim 1, wherein:
the processor is configured not to transmit an overwriting command to register the setting information in an overwriting manner in the information processing apparatus and to transmit an addition command to additionally register the setting information in the information processing apparatus in a case where the setting information includes setting information concerning security.

3. The management apparatus according to claim 1, wherein:
the processor is configured to acquire registered setting information registered in the information processing apparatus and transmit a registration prohibition command to prohibit registration of setting information other than remote setting to the information processing apparatus in a case where the setting information includes setting information concerning security.

4. The management apparatus according to claim 3, wherein:
the processor is configured to give a notification in a case where the acquired registered setting information and the setting information are different.

5. The management apparatus according to claim 1, wherein:
the processor is configured to transmit, to the information processing apparatus, an overwriting command to register the setting information in an overwriting manner in the information processing apparatus and an addition command to additionally register the setting information in the information processing apparatus in a case where the setting information does not include setting information concerning security.

6. The management apparatus according to claim 2, wherein:
the processor is configured to transmit, to the information processing apparatus, an overwriting command to register the setting information in an overwriting manner in the information processing apparatus and an addition command to additionally register the setting information in the information processing apparatus in a case where the setting information does not include setting information concerning security.

7. The management apparatus according to claim 3, wherein:
the processor is configured to transmit, to the information processing apparatus, an overwriting command to register the setting information in an overwriting manner in the information processing apparatus and an addition command to additionally register the setting information in the information processing apparatus in a case where the setting information does not include setting information concerning security.

8. The management apparatus according to claim 4, wherein:
the processor is configured to transmit, to the information processing apparatus, an overwriting command to register the setting information in an overwriting manner in the information processing apparatus and an addition command to additionally register the setting information in the information processing apparatus in a case where the setting information does not include setting information concerning security.

9. The management apparatus according to claim 1, wherein:
the information processing apparatus is connectable to a plurality of different communication lines.

10. The management apparatus according to claim 2, wherein:
the information processing apparatus is connectable to a plurality of different communication lines.

11. The management apparatus according to claim 3, wherein:
the information processing apparatus is connectable to a plurality of different communication lines.

12. The management apparatus according to claim 4, wherein:
the information processing apparatus is connectable to a plurality of different communication lines.

13. The management apparatus according to claim 5, wherein:
the information processing apparatus is connectable to a plurality of different communication lines.

14. The management apparatus according to claim 6, wherein:
the information processing apparatus is connectable to a plurality of different communication lines.

15. The management apparatus according to claim 7, wherein:
the information processing apparatus is connectable to a plurality of different communication lines.

16. The management apparatus according to claim 8, wherein:
the information processing apparatus is connectable to a plurality of different communication lines.

17. The management apparatus according to claim 9, wherein:
the plurality of different communication lines are communication lines for which a plurality of different security levels are set.

18. The management apparatus according to claim 10, wherein:
the plurality of different communication lines are communication lines for which a plurality of different security levels are set.

19. A non-transitory computer readable medium storing a program causing a computer to execute a process for management, the process comprising, in a case where setting information is transmitted to an information processing apparatus in which setting information concerning security of the information processing apparatus is remotely settable for each user, performing control so that setting information already set in the information processing apparatus is not updated.

20. A management method comprising:
in a case where setting information is transmitted to an information processing apparatus in which setting information concerning security of the information processing apparatus is remotely settable for each user, performing control so that setting information already set in the information processing apparatus is not updated.
